(19) United States
(12) Patent Application Publication
(10) Pub. No.: US 2007/0047143 A1
(43) Pub. Date: Mar. 1, 2007

(54) Magnetic head slider having contacted portion at air outflow end side

(75) Inventor: Tsuyoshi Matsumoto, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/506,087

(22) Filed: Aug. 16, 2006

(30) Foreign Application Priority Data
Aug. 31, 2005 (JP) 2005-251104

(51) Int. Cl. G11B 5/60

(52) U.S. Cl. 360/234.3

(57) ABSTRACT

A magnetic head slider is provided. The magnetic head slider has a leading-side protrusion surface and a protruding magnetic element surrounding surface disposed at a surface of a slider opposing a disc. A first flow path that has the form of a groove is disposed between the magnetic element surrounding surface and the leading-side protrusion surface. A contracted portion is provided in the first flow path so as to be positioned closer to a trailing side compared to a swing fulcrum of the slider.

This application claims the benefit of Japanese Patent Application 2005-251104 filed on Aug. 31, 2005 which is hereby incorporated by reference.

### BACKGROUND

1. FIELD

A magnetic head slider having a magnetic element that performs a recording operation and/or reproducing operation on a magnetic disc is provided. Related Art

A disc-opposing surface of a magnetic head slider ordinarily has a groove and a protruding surface. The groove is disposed at the lowest position of the disc-opposing surface and is used to produce negative pressure. The protruding surface is used to produce positive pressure. A flying height of the magnetic head slider has been stabilized by, for example, forming the groove and the protruding surface with a suitable shape or setting the ratio between the areas of the groove and the protruding surface that they occupy at the disc-opposing surface to a proper ratio.

However, the flying height tends to become unstable due to a change in air pressure or a reduction in an air inflow amount resulting from, for example, a reduction in peripheral speed caused by size reduction of a magnetic disc.

According to, for example, Japanese Unexamined Patent Application Publication No. 8-124140, a contracted portion is formed at a portion of a recess formed in a disc-opposing surface. Since flow velocity at the contracted portion is reduced, positive pressure tends to be produced near the contracted portion.

However, in Japanese Unexamined Patent Application Publication No. 8-124140, since the contracted portion that is formed at the recess is formed at an air-inflow-end side of a slider, the contracted portion increases the positive pressure that is produced at the air-inflow-end side. In addition, since the width of the recess at an air-outflow-end side is greater than that of the contracted portion, negative pressure that is produced at the air-outflow-end side is increased. In such a structure, when the air pressure (for example, the air density) is reduced, a pitch angle tends to become large, thereby considerably reducing the flying height.

In Japanese Unexamined Patent Application Publication No. 8-124140, the relationship between the contracted portion formed at the recess and the change in air pressure (for example, the air density) is not discussed, and the contracted portion is also provided for a different purpose (for example, for preventing adhesion of, for example, dust to the disc-opposing surface).

### SUMMARY

A magnetic head slider comprises a slider element. A recording and/or reproducing magnetic element is disposed at an end surface of the slider element at an air-outflow-end side thereof. At least one air-inflow-end-side protrusion surface is disposed at an air-inflow-end side of a surface of the slider element opposing a magnetic disc and protrudes towards the magnetic disc. A magnetic element surrounding surface is disposed at the air-outflow-end side of the slider element so as to protrude towards the magnetic disc. A first flow path is disposed between the magnetic element surrounding surface and the at least one air-inflow-end-side protrusion surface and having the form of a groove. A contracted portion disposed in the first flow path so as to be positioned closer to the air-outflow-end side of the slider element compared to a swing fulcrum of the slider element.

At the contracted portion, flow velocity is reduced, thereby producing positive pressure. When the contracted portion is disposed closer to the air-outflow-end side compared to the swing fulcrum of the slider, the pitch angle of the slider is smaller under a low air pressure environment than under a high air pressure environment, so that a change in flying height resulting from a change in air pressure (for example, air density) can be effectively reduced.

In one form, the at least one air-inflow-end-side protrusion surface comprises air-inflow-end-side protrusion surfaces that are divided in a widthwise direction that is orthogonal to a lengthwise direction extending from the air-inflow-end side towards the air-outflow-end side. The magnetic head slider further comprises a second flow path disposed between the air-inflow-end-side protrusion surfaces. The second flow path is connected to the first flow path. This structure is desirable because air flows smoothly from the air-inflow-end side of the slider to the air-outflow-end side of the slider, so that a change in the flying height resulting from a change in air pressure (for example, air density) is more effectively reduced.

In another preferred embodiment, a height of a bottom surface defining the first flow path and/or a height of a bottom surface defining the second flow path is greater than a height of a bottom surface defining a groove serving as a negative pressure producing surface and is less than a height of the magnetic element surrounding surface and a height of the at least one air-inflow-end-side protrusion surface. This is desirable because a change in flying height resulting from a change in air pressure (for example, air density) can be more effectively reduced.

In another preferred embodiment, the magnetic head slider further comprises a plurality of rail surfaces protruding towards the magnetic disc and connecting the magnetic element surrounding surface and the at least one air-inflow-end-side protrusion surface. The first flow path is disposed between the rail surfaces, and a groove serving as a negative pressure producing surface is disposed at sides of the rail surfaces in the widthwise direction. This structure is desirable because, for example, a proper positive pressure can be produced near the contracted portion and a proper balance between positive pressures and negative pressure can be easily achieved.

In another preferred emboidment, T1/T2 is in a range of about 0.05 to 0.5, where T1 denotes a width of the contracted portion and T2 denotes a width of an air-inflow-end-side end of the first flow path. Accordingly, a change in flying height resulting from a change in air pressure (for example, air density) can be more effectively reduced.

In another preferred embodiment, L2/L1 is equal to or greater than 0.57, where L1 denotes a length of the slider element and L2 denotes a length between the position of the contracted portion and an end surface of the slider element at the air-inflow-end side thereof. Accordingly, a change in flying height resulting from a change in air pressure (that is, air density) can be more effectively reduced.

As mentioned above, at least one air-inflow-end-side protrusion surface is disposed at the air-inflow-end side of the surface of the slider element opposing a magnetic disc and protrudes towards the magnetic disc, a magnetic element surrounding surface is disposed at an air-outflow-end side of the slider element so as to protrude towards the magnetic disc, a first flow path is disposed between the magnetic element surrounding surface and the at least one air-inflow-end-side protrusion surface and has the form of a groove, and a contracted portion is disposed in the first flow path so as to be positioned closer to the air-outflow-end side of the slider element compared to the swing fulcrum of the slider element.

At the contracted portion, flow velocity is reduced, thereby producing positive pressure. When the contracted portion is disposed closer to the air-outflow-end side compared to the swing fulcrum of the slider, the pitch angle of the slider is smaller under a low air pressure environment than under a high air pressure environment, so that a change in flying height resulting from a change in air pressure (for example, air density) can be effectively reduced.

### DRAWINGS

FIG. 1 is a perspective view in which a disc-opposing surface of a magnetic head slider according to an embodiment facing upward;

FIG. 2 is a plan view of the magnetic head slider shown in FIG. 1 as seen from a disc-opposing surface side;

FIG. 3 is a plan view of a contracted portion that is different from a contracted portion shown in FIGS. 1 and 2;

FIG. 4 is a conceptual diagram for illustrating positive pressures acting on the slider under high air pressure (for example, under air pressure at a flatland at sea level (0 meters));

FIG. 5 is a conceptual diagram for illustrating positive pressures acting on the slider under low air pressure (for example, under air pressure at a highland at 3048 meters above sea level);

FIG. 6 is a partial perspective view of a magnetic head device in which the magnetic head slider is mounted to a supporting member;

FIG. 7 is a partial side view of the magnetic disc device, showing a state in which the magnetic head slider according to a preferred embodiment is stopped above a magnetic disc;

FIG. 8 is a partial side view of the magnetic disc device, showing a state after the magnetic head slider according to a preferred emboidment has flown from the magnetic disc;

FIG. 9 is a graph showing the relationship between height difference sensitivity and T1/T2 of each magnetic head slider used in an experiment; and

FIG. 10 is a graph showing the relationship between height difference sensitivity and L2 (L2/L1) of each magnetic head slider used in another experiment.

### DESCRIPTION OF THE PREFERRED EMBODIMENTS

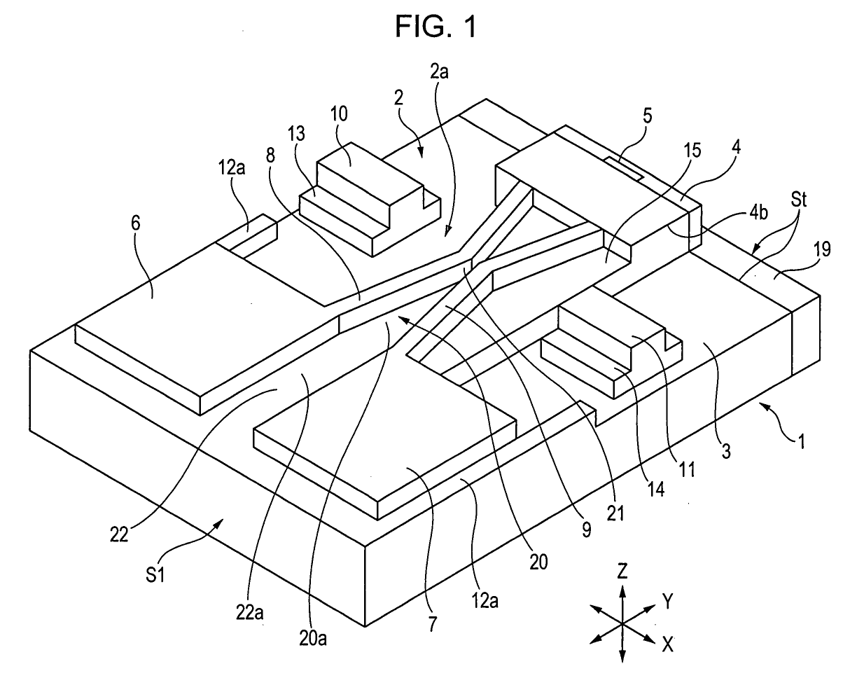

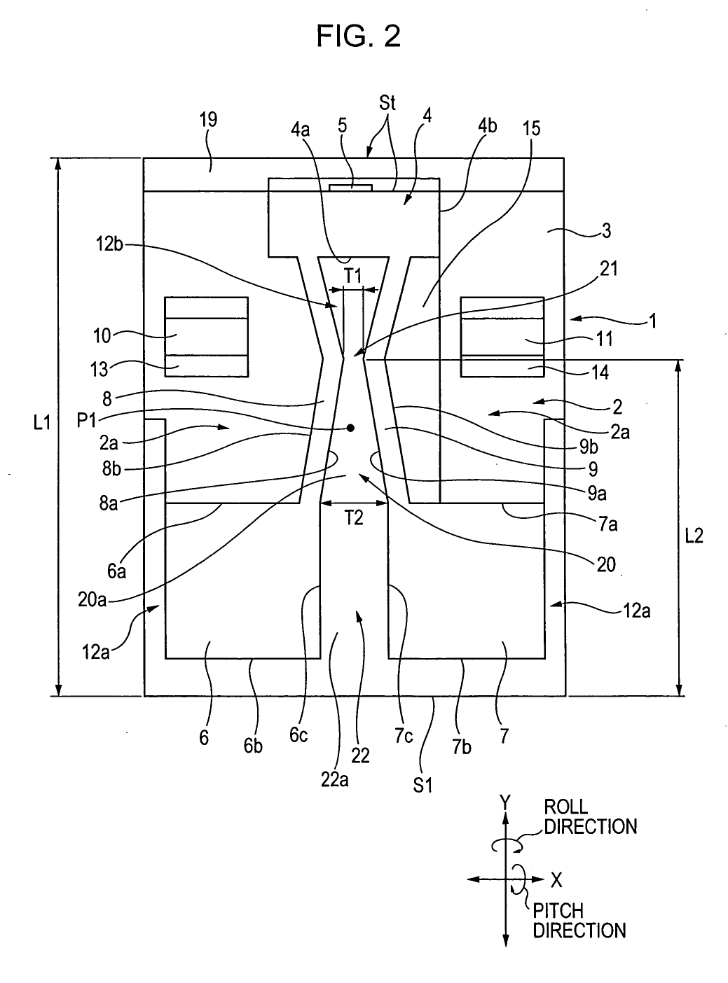

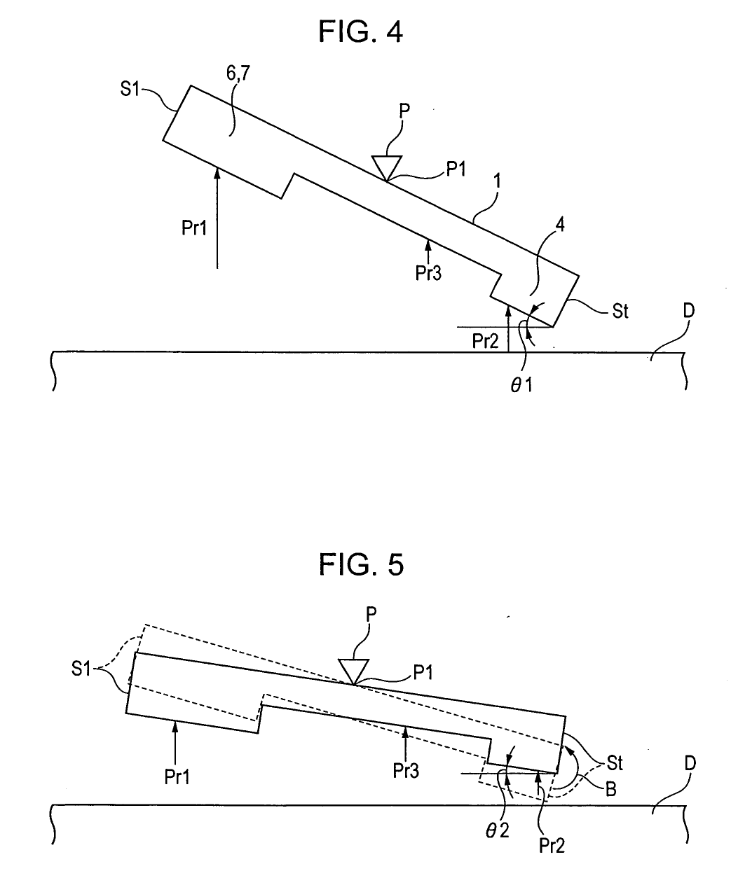

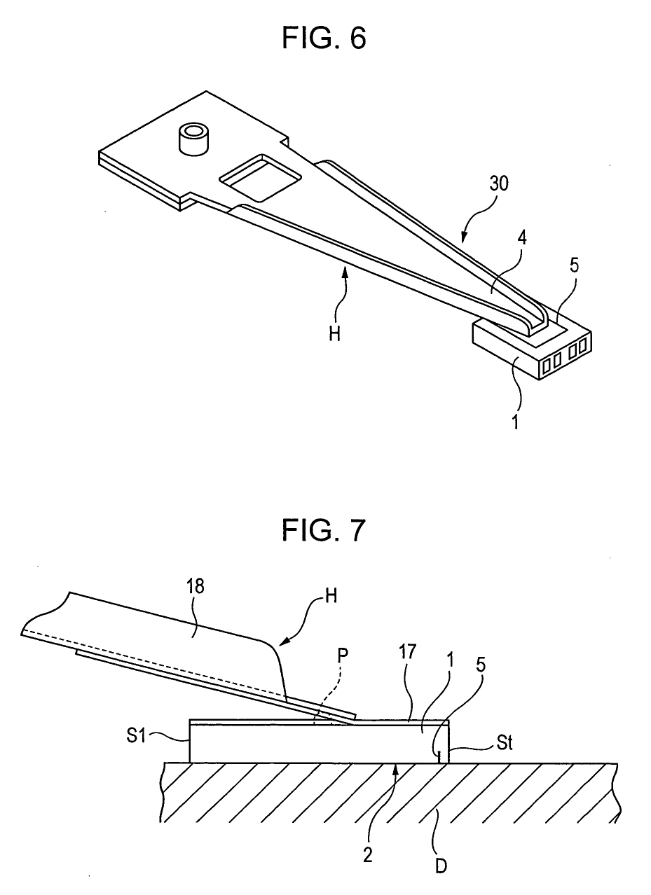

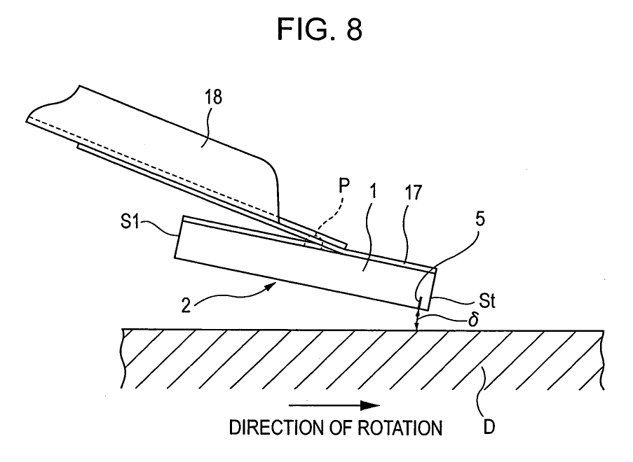

FIG. 1 is a perspective view in which a disc-opposing surface of a magnetic head slider according to an embodiment facing upward. FIG. 2 is a plan view of the magnetic head slider shown in FIG. 1 as seen from a disc-opposing surface side. FIG. 4 is a conceptual diagram for illustrating positive pressures acting on the slider under high air pressure (for example, under air pressure at a flatland at sea level (0 meters)). FIG. 5 is a conceptual diagram for illustrating positive pressures acting on the slider under low air pressure (for example, under air pressure at a highland at 3048 meters above sea level). FIG. 6 is a partial perspective view of a magnetic head device in which the magnetic head slider is mounted to a supporting member. FIG. 7 is a partial side view of the magnetic disc device, showing a state in which the magnetic head slider according to the present invention is stopped above a magnetic disc. FIG. 8 is a partial side view of the magnetic disc device, showing a state after the magnetic head slider according to the present invention has flown from the magnetic disc.

A magnetic head slider 1 shown in FIGS. 1 and 2 is part of a magnetic head device H. For example, as shown in FIG. 6, the magnetic head slider 1 is mounted to a supporting member 30 which resiliently supports the magnetic head slider 1 from a side opposite to a disc-opposing surface 2. The supporting member 30 comprises a load beam 18 and a flexure 17. The load beam 18 is formed of a plate spring. The flexure 17 is provided at an end of the load beam 18, which is formed of a thin plate spring, and resiliently supports the magnetic head slider 1.

The magnetic head device H is installed in a magnetic disc apparatus, and records a magnetic signal onto a magnetic disc D disposed in the magnetic disc apparatus or reproduces the magnetic signal recorded on the magnetic disc D.

FIG. 7 shows a state in which the magnetic head slider 1 of the magnetic head device H is stopped above the magnetic disc D disposed in the magnetic disc apparatus. From this stopped state shown in FIG. 7, the magnetic head slider 1 flies above the magnetic disc D due to the rotation of the magnetic disc D to perform the aforementioned recording operation or reproducing operation (see FIG. 8).

As shown in FIG. 7, the magnetic head slider 1 is adhered and secured to the lower surface of the flexure 17 from the side opposite to the side of the disc-opposing surface 2. As shown in FIG. 7, for example, a spherical pivot P protruding upward in the figure is formed at the flexure 17. An end of this pivot P is in contact with the load beam 18.

In the state shown in FIG. 7, the magnetic head slider 1 is urged with a weak resilient force against a recording surface of the magnetic disc D by the supporting member 30. As shown in FIG. 8, when the magnetic disc D starts rotating, a leading-side end surface S1 of the magnetic head slider 1 receives an airflow and is raised upward with the end of the pivot P being a swing fulcrum. When the magnetic head slider 1 flies above the magnetic disc D, the magnetic head slider 1 swings in a pitch direction (for example, a direction of rotation around the illustrated X direction as an axis of rotation) on the end of the pivot P serving as a swing fulcrum so as to follow the undulation of the magnetic disc D. As shown in FIG. 8, the magnetic head slider 1 flies at a flying height σ from the magnetic disc D. As shown in FIG. 8, the term “flying height” broadly refers to a straight-line distance (shortest distance) from a surface of a magnetic element 5 to the surface of the magnetic disc D.

As shown in FIGS. 1 and 2, an air inflow end of the magnetic head slider 1 is called the “leading-side end surface S1,” and an air outflow end thereof is called a “trailing-side end surface St.” Terms which do not indicate the end surfaces themselves, for example, a “direction facing the leading-side end surface” or “in the direction of the leading-side end surface” and a “direction facing the trailing-side end surface” or “in the direction of the trailing-side end surface” will hereunder be referred to as, respectively, the “leading side S1” and the “trailing side St.” The direction from the leading-side end surface S1 towards the trailing-side end surface St is defined as the lengthwise direction (illustrated Y direction), and the direction orthogonal to the lengthwise direction is defined as the widthwise direction (illustrated X direction).

The magnetic head slider 1 shown in FIGS. 1 and 2 is formed of, for example, alumina titanium carbide.

As shown in FIGS. 1 and 2, the disc-opposing surface 2 of the magnetic head slider 1 has a magnetic element surrounding surface 4 formed at the trailing side St so as to protrude towards the magnetic disc D from a groove 3 formed as a negative pressure producing surface. In addition, as shown in FIGS. 1 and 2, the magnetic element 5 is formed at the trailing side St of the magnetic head slider 1. The magnetic element 5 may use a composite element including a reproduction MR element (as typified by a spin-valve thin-film element making use of a magnetoresistive effect) and a recording inductive element, or may use only one of the MR element and the inductive element. As shown in FIGS. 1 and 2, the vicinity of the magnetic element 5 is covered with a protective film 19 formed of, for example, Al₂O₃, and the protective film 19 is also part of the magnetic element surrounding surface 4.

The surface of the magnetic element 5 is exposed from the magnetic element surrounding surface 4, and is used to perform a recording operation or a reproducing operation on the magnetic disc D.

As shown in FIGS. 1 and 2, two divided leading-side protrusion surfaces 6 and 7 that protrude to the same height as the magnetic element surrounding surface 4 and that are formed in the widthwise direction (illustrated X direction) are provided at the leading side S1 of the magnetic head slider 1.

Further, as shown in FIGS. 1 and 2, elongated rail surfaces 8 and 9 extending from the leading side S1 to the trailing side St protrude to the same height as the magnetic element surrounding surface 4 and the leading-side protrusion surfaces 6 and 7 so that the rail surface 8 is disposed between a trailing-side end 6a of the leading-side protrusion surface 6 and a leading-side end 4a of the magnetic element surrounding surface 4 and the rail surface 9 is disposed between a trailing-side end 7a of the leading-side protrusion surface 7 and the leading-side end 4a of the magnetic element surrounding surface 4. The rail surface 8 connects the leading-side protrusion surface 6 and the magnetic element surrounding surface 4 to each other and the rail surface 9 connects the leading-side protrusion surface 7 and the magnetic element surrounding surface 4 to each other.

As shown in FIGS. 1 and 2, side protrusion surfaces 10 and 11 whose heights are the same as the height of the magnetic element surrounding surface 4 are formed at respective sides in the widthwise direction (illustrated X direction) of the rail surfaces 8 and 9 . When the magnetic head slider 1 is tilted above the magnetic disc D in the roll direction (that is, the direction of rotation around the illustrated Y direction as an axis of rotation), the side protrusion surfaces 10 and 11 act as positive pressure producing surfaces that limit a tilt angle of the slider 1 with respect to the surface of the magnetic disc D and that restrict, for example, collision of both ends (in the widthwise direction or the illustrated X direction) of the magnetic head slider 1 against the magnetic disc D.

As shown in FIGS. 1 and 2, the groove 3 of the disc-opposing surface 2 produces negative pressure.

As shown in FIGS. 1 and 2, a first flow path 20 is formed between the rail surfaces 8 and 9, and has a grooved form between an inside end 8a of the rail surface 8 and an inside end 9a of the rail surface 9.

As shown in FIGS. 1 and 2, a second flow path 22 is formed between the leading-side protrusion surfaces 6 and 7 that are divided in the widthwise direction. The second flow path 22 has a grooved form between an inside end 6c of the leading-side protrusion surface 6 and an inside end 7c of the leading-side protrusion surface 7. The first flow path 20 and the second flow path 22 are connected to each other.

The heights of bottom surfaces 20a and 22a defining the respective first flow path 20 and second flow path 22 are less than the heights of the magnetic element surrounding surface 4, the leading-side protrusion surfaces 6 and 7, and the rail surfaces 8 and 9, and are greater than the height of the groove 3 . The bottom surface 20a defining the first flow path 20 and the bottom surface 22a defining the second flow path 22 are flat surfaces having the same height.

Surfaces whose heights are the same as those of the bottom surfaces 20a and 22a of the respective flow paths 20 and 22 are provided as step surfaces at leading-side ends 6b and 7b of the respective leading-side protrusion surfaces 6 and 7, and are provided as side step surfaces 12a at a side (in the widthwise direction or the illustrated X direction) of the leading-side protrusion surface 6 and a side (in the widthwise direction) of the leading-side protrusion surface 7. The side step surfaces 12a extend further towards the trailing side St from the trailing-side ends 6a and 7a of the respective leading-side protrusion surfaces 6 and 7. Portions of the groove 3 disposed closer to the trailing side St compared to the trailing-side ends 6a and 7a of the respective leading-side protrusion surfaces 6 and 7 are interposed between the side step surface 12a and the rail surface 8 and between the side step surface 12a and the rail surface 9. By virtue of this structure, air enters the groove 3, so that negative pressure having a suitable magnitude can be produced at the groove 3.

Surfaces whose heights are the same as those of the bottom surfaces 20a and 22a of the respective flow paths 20 and 22 are also provided as step surfaces 13 and 14 at leading-side ends 10a and 11a of the respective side protrusion surfaces 10 and 11, and are provided as a step surface 15 at an outer end 9b (in the widthwise direction or the illustrated X direction) of the rail surface 9.

The distinctive features of the embodiment are that the first flow path 20 having the form of a groove is formed between the magnetic element surrounding surface 4 and the leading-side protrusion surfaces 6 and 7 and that a contracted portion 21 is formed in the first flow path 20 so as to be disposed closer to the trailing side (air-outflow-end side) St compared to a swing fulcrum P1 of the slider 1. The swing fulcrum P1 is situated at exactly an end of the pivot P, and substantially at the center of the slider 1.

The contracted portion 21 will be described. A cross-sectional area of a portion of the first flow path 20 where the contracted portion 21 is formed is smaller than a cross-sectional area of a portion of the first flow path 20 situated closer to the leading side S1 compared to the contracted portion 21 and is equal to or smaller than a cross-sectional area of a portion of the first flow path 20 situated closer to the trailing side St compared to the contracted portion 21. The cross-sectional areas are cut off from planes defined by the height direction (illustrated Z direction) and the widthwise direction (illustrated X direction).

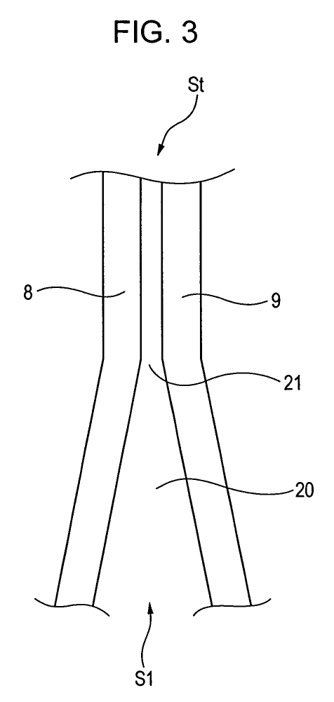

To satisfy these conditions, in the embodiment shown in FIGS. 1 and 2, the height of the bottom surface 20a defining the first flow path 20 is constant. A width T1 of the contracted portion 21 is smallest in the first flow path 20. As shown in FIGS. 1 and 2, the widths of the portions of the first flow path 20 situated closer the leading side S1 and the trailing side St compared to the contracted portion 21 are larger than the width T1 of the contracted portion 21. To form the contracted portion, the width of the portion of the first flow path 20 situated closer to the leading side S1 compared to the contracted portion needs to be larger than the width T1 of the contracted portion 21. The width of the portion of the first flow path 20 situated closer to the trailing side St compared to the contracted portion 21 is either equal to or greater than the width T1 of the contracted portion 21. The case in which the width of the portion of the first flow path 20 that is situated closer to the trailing side St compared to the contracted portion 21 is the same as the width T1 of the contracted portion 21 is shown in FIG. 3. In FIG. 3, the width of the portion of the first flow path situated closer to the trailing side St compared to the contracted portion 21 is the same as the width of the contracted portion 21 and constant, it is possible to form such a constant width area to a predetermined length and another area situated towards the trailing side St from this constant width area such that its width increases.

In addition, for example, a plurality of contracted portions 21 may be formed in the first flow path 20. In such a case, the widths T1 of the contracted portions 21 do not all need to be the same smallest value in the first flow path 20. Even if each width is not the smallest in the first flow path 20, each contracted portion serves as a contracted portion as long as the aforementioned conditions are satisfied. When the width T1 of the contracted portion 21 is 0, a flying height is considerably reduced by a reduction in air density. It is desirable that the contracted portion 20 be provided closer to the leading side S1 compared to the leading-side end 4a of the magnetic element surrounding surface 4.

It is desirable that the width of a portion of the first flow path 20 close to the leading-side end 4a of the magnetic element surrounding surface 4 be larger than the width T1 of the contracted portion 20. This is because positive pressure that is produced near the contracted portion 21 and positive pressure that is produced at the magnetic element surrounding surface 4 are produced in a suitably divided state, so that each positive pressure is easily controllable.

In FIGS. 1 and 2, the width T1 of the contracted portion 21 is small. It is possible for a portion of the bottom surface 20a where the contracted portion 21 is formed to protrude more than the other portions at the first flow path 20, so that the height of the first flow path 20 where the contracted portion 21 is formed (for example, the depth of the grooved form) is less than the heights of the other portions at the first flow path 20 (for example, the depth of the grooved form). In this preferred emboidment, it is possible for a cross-sectional area of the portion of the first flow path 20 where the contracted portion 21 is formed to be smaller than the cross-sectional area of the portion of the first flow path 20 situated closer to the leading side S1 compared to the contracted portion 21 and to be equal to or smaller than the cross-sectional area of the portion of the first flow path 20 situated closer to the trailing side St compared to the contracted portion 21. The cross-sectional areas are cut off from planes defined by the height direction (illustrated Z direction) and the widthwise direction (illustrated X direction).

The portion of the bottom surface 20a where the contracted portion 21 is formed cannot be easily formed to protrude more than the other portions at the first flow path 20, and the depth of the first flow path 20 itself is on the order of about 0.1 μm at most. Therefore, even if the depth of the first flow path 20 is changed, the difference between the cross-sectional area of the portion where the contracted portion 21 is formed and those of the other portions cannot be effectively made large. It is desirable to control the width T1 of the portion of the first flow path 20 where the contracted portion 21 is formed.

As described above, in the embodiment, the contracted portion 21 is formed in the first flow path 20, so that the flow velocity of air flowing in the first flow path 20 is reduced near the contracted portion 21, thereby producing positive pressure near the contracted portion 21. The contracted portion 21 is disposed closer to the trailing side St compared to the swing fulcrum P1, so that the positive pressure that is produced close to the contracted portion 21 is produced at a location closer to the trailing side St compared to the swing fulcrum P1. The structure of the embodiment is such that a change in flying height resulting from a change in air pressure (for example, air density) is smaller than that in a related structure. The principle of this structure is described with reference to FIGS. 4 and 5.

FIG. 4 is a conceptual diagram that illustrates positive pressures acting on the slider under high air pressure (for example, under air pressure at a flatland at sea level (0 meters)). Symbol Pr1 denotes by a vector length the magnitude of the positive pressure that is produced between the magnetic disc D and the leading-side protrusion surfaces 6 and 7. Symbol Pr2 denotes by a vector length the magnitude of the positive pressure that is produced between the magnetic disc D and the magnetic element surrounding surface 4. By way of example, the longer the vector length, the higher the positive pressure. As shown in FIGS. 1 and 2, the total of the areas of the leading-side protrusion surfaces 6 and 7 is greater than the area of the magnetic element surrounding surface 4. Therefore, the positive pressure Pr1 that is produced between the magnetic disc D and the leading-side protrusion surfaces 6 and 7 is greater than the positive pressure Pr2 that is produced between the magnetic disc D and the magnetic element surrounding surface 4.

In the embodiment, since the contracted portion 21 is formed in the first flow path 20, positive pressure Pr3 is produced near the contracted portion 21. The positive pressure Pr3 is produced at a location that is closer to the magnetic element surrounding surface 4 compared to the swing fulcrum P1. Due to the balance between the negative pressure that is produced at the groove 3 and the positive pressures Pr1, Pr2, and Pr3, the leading side S1 of the slider 1 flies to a high height and the trailing side St of the slider 1 flies near the magnetic disc D. The pitch angle (for example, the tilting of the magnetic element surrounding surface 4 with respect to the magnetic disc surface) is θ1.

FIG. 5 is a conceptual diagram that illustrates positive pressures acting on the slider under low air pressure (for example, under air pressure at a highland at 3048 meters above sea level).

The slider that is shown by dotted lines in FIG. 5 is in a flying state where the positive pressure Pr3 is not produced. When the air pressure is reduced, the amount of air flowing between the slider 1 and the magnetic disc D is reduced, thereby reducing the air density between the slider 1 and the magnetic disc D. The positive pressures Pr1 and Pr2 and the negative pressure are all similarly reduced. The flying height of the slider that is shown by dotted lines is considerably reduced compared to that when the air pressure is high.

In a preferred embodiment, since the contracted portion 21 is provided in the first flow path 20, the positive pressure Pr3 is produced near the contracted portion 21. As shown in FIG. 5, when the flying height of the slider is reduced as a result of a reduction in all of the positive pressures Pr1 and Pr2 and the negative pressure, a distance Hi between the magnetic disc D and the vicinity of the contracted portion 21 is reduced. Since air stagnates near the contracted portion 21 (for example, flow velocity is reduced) when the distance H1 is reduced, the pressure Pr3 that is produced near the contracted portion 21 is greater than that produced in FIG. 4, so that the trailing-side end surface St of the slider 1 is lifted upward as indicated by arrow B. When the trailing-side end surface St of the slider 1 is lifted upward, a pitch angle θ2 is smaller than the pitch angle θ1 shown in FIG. 4, and the flying height does not change very much compared to that when the air pressure is high. Therefore, compared to the case in which the positive pressure Pr3 is not produced, the change in the flying height resulting from a change in air pressure (for example, air density) can be made smaller.

In this preferred embodiment, when the width at the contracted portion 21 that is formed in the first flow path 20 is T1 and the width at the leading-side end of the first flow path 20 (for example, the width between the boundary of the first flow path 20 and the leading-side protrusion surfaces 6 and the boundary of the first flow path 20 and the leading-side protrusion surface 7) is T2, it is desirable that T1/T2 be in the range of from about 0.05 to about 0.5.

When the length of the slider 1 is L1 and the length between the contracted portion 21 and the leading-side end surface S1 of the slider 1 is L2, it is desirable that L2/L1 be equal to or greater than about 0.57.

As mentioned above, by setting the width T1 of the contracted portion 21 to a suitable value and by forming the contracted portion 21 at a proper position, it is possible to effectively reduce a change in the flying height resulting from a change in air pressure (for example, air density).

In the embodiment shown in FIGS. 1 and 2, the protruding rail surface 8 connects the leading-side end 6a of the leading-side protrusion surface 6 to the leading-side end 4a of the magnetic element surrounding surface 4, the protruding rail surface 9 connects the leading-side end 7a of the leading-side protrusion surface 7 to the leading-side end 4a of the magnetic element surrounding surface 4, and the first flow path 20 is formed between the elongated rail surfaces 8 and 9. By providing the elongated rail surfaces 8 and 9, the first flow path 20 can be easily formed from the leading-side protrusion surfaces 6 and 7 to the magnetic element surrounding surface 4. The inside ends 8a and 9a of the respective rail surfaces 8 and 9 act as side walls restricting the direction of air flow, so that it is possible to properly guide the air to the magnetic element surrounding surface 4 or produce positive pressure of the proper magnitude near the contracted portion 21.

In another preferred embodiment, it is possible to form the groove 3 as a negative pressure producing area outwardly from an outer end 8b of the rail surface 8 and the outer end 9b of the rail surface 9 in the widthwise direction (for example, the illustrated X direction), so that the balance between the positive pressures and the negative pressure can be properly maintained.

In the embodiment shown in FIGS. 1 and 2, the second flow path 22 and the first flow path 20 are continuously formed between the leading-side protrusion surfaces 6 and 7, and the bottom surface 20a defining the first flow path 20 and the bottom surface 22a defining the second flow path 22 are flat surfaces of the same height. Since there is no obstacle, such as a step, in the first flow path 20 and the second flow path 22, it is possible to properly guide air to the magnetic element surrounding surface 4 more easily and to properly generate positive pressures at the contracted portion 21 and the magnetic element surrounding surface 4.

As shown in FIGS. 1 and 2, the height of the bottom surfaces 20a and 22a of the respective first flow path 20 and the second flow path 22 is less than the height of the magnetic element surrounding surface 4 and the height of the leading-side protrusions surfaces 6 and 7, and is greater than the height of the bottom surface defining the groove 3. It is possible to stabilize the flying posture of the slider 1 and to reduce a change in the flying height of the magnetic head slider 3 resulting from a change in air pressure (for example, air density). For example, when the height of the bottom surfaces 20a and 22a of the respective first flow path 20 and second flow path 22 is the same as the height of the groove 3, the negative pressure area is increased. As a result, even if the air inflow amount is large, the flying height of the magnetic head slider 1 is considerably reduced. This increases the probability of the magnetic head slider 1 colliding with the magnetic disc D having an uneven surface. In addition, air that has passed through the first flow path 20 collides with the leading-side end 4a of the tall magnetic element surrounding surface 4 and the flow of air tends to be disturbed, thereby, for example, preventing the air from properly flowing to the magnetic element surrounding surface 4. Therefore, a change in the flying height of the magnetic head slider 1 resulting from instability of the flying posture of the slider 1 and a change in air pressure (that is, air density) tends to be increased. It is desirable for the height of the bottom surfaces 20a and 22a of the respective first flow path 20 and second flow path 22 to be less than the height of the magnetic element surrounding surface 4 and the height of the leading-side protrusion surfaces 6 and 7 and to be greater than the height of the bottom surface defining the groove 3.

In the embodiment shown in FIGS. 1 and 2, the height of the rail surfaces 8 and 9 is the same as the height of the magnetic element surrounding surface 4 and the height of the leading-side protrusion surfaces 6 and 7, the height of the rails 8 and 9 may be less than the height of the magnetic element surrounding surface 4 and the height of the leading-side protrusion surfaces 6 and 7.

### EXAMPLES

A plurality of magnetic head sliders having the form shown in FIGS. 1 and 2 were produced.

The magnetic head sliders have different widths T1 and T2 as shown in Table 1 below. The width T1 is that of the contracted portion 21 at the first flow path 20 formed between the rail surfaces 8 and 9, and the width T2 is that of the leading-side end of the first flow path 20.

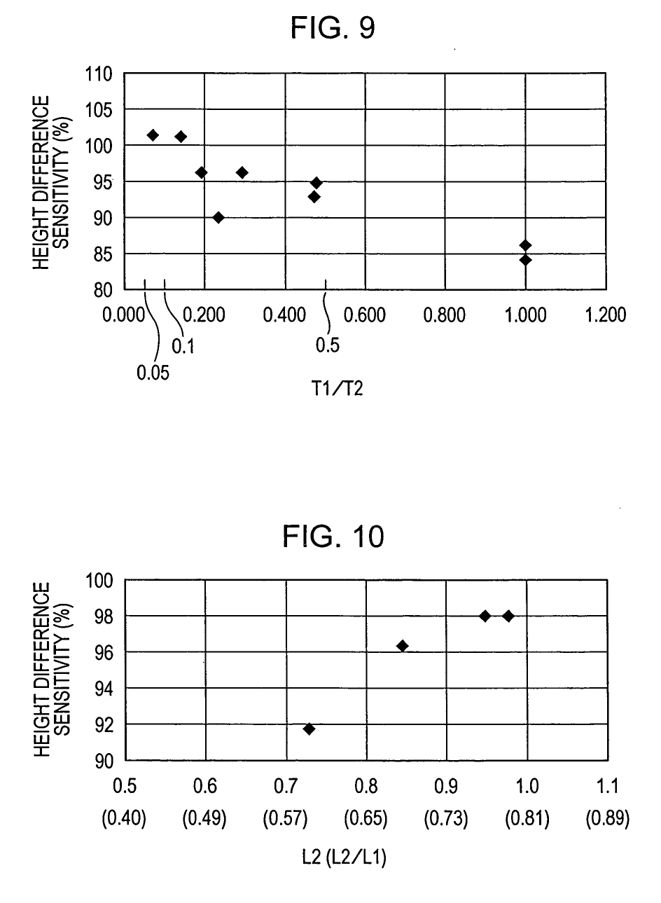

Flying heights of the magnetic head sliders under air pressure at a flatland at sea level (0 meters) and flying heights of the magnetic head sliders under air pressure at a highland at 3048 meters above sea level were measured. The relationship between T1/T2 of each magnetic head slider and height difference sensitivity was determined. The height difference sensitivity is equal to (flying height of magnetic head slider at a highland/flying height of magnetic head slider at a flatland)×100%. The experimental results are shown in Table 1 and FIG. 9.

TABLE 1

| LEADING-SIDE | CONTRACTED | HEIGHT |
|---|---|---|
| WIDTH T2 | PORTION | DIFFERENCE |
| (um) | WIDTH T1 (um) | SENSITIVITY (%) |
| 54 | 54 | 84.2 |
| 104 | 104 | 86 |
| 104 | 50 | 94.4 |
| 104 | 30 | 96.2 |
| 104 | 20 | 96.3 |
| 84 | 40 | 92.1 |
| 84 | 20 | 90 |
| 144 | 20 | 101.3 |
| 144 | 10 | 101.6 |

As shown in FIG. 9, when T1/T2 is in the range of from about 0.05 to about 0.5, the height difference sensitivity can be equal to or greater than 90%. When T1/T2 is in the range of from about 0.05 to about 0.2, the height difference sensitivity can be equal to or greater than 95%.

A plurality of magnetic head sliders having different lengths L2, measured from the leading-side end surfaces S1 of the respective sliders 1 to the contracted portions 21, were produced.

Flying heights of the magnetic head sliders under air pressure at a flatland at sea level (0 meters) and flying heights of the magnetic head sliders under air pressure at a highland at 3048 meters above sea level were measured. The relationship between L2 (L2/L1) of each magnetic head slider and height difference sensitivity was determined. The height difference sensitivity is equal to (flying height of magnetic head slider at a highland/flying height of magnetic head slider at a flatland)×100%. The lengths L1 of the magnetic head sliders 1 were all 1.235 mm. The experimental results are shown in FIG. 10.

As shown in FIG. 10, when L2 is equal to or greater than 0.7 mm (or L2/L1 is equal to or greater than 0.57), the height difference sensitivity is equal to or greater than 92%. When L2 is equal to or greater than 0.9 mm (or L2/L1 is equal to or greater than 0.73), the height difference sensitivity is equal to or greater than 98%.

What is claimed is:

1. A magnetic head slider comprising:
a slider element;
a recording and/or reproducing magnetic element;
at least one air-inflow-end-side protrusion surface;
a magnetic element surrounding surface;
a first flow path; and
a contracted portion disposed in the first flow path so as to be positioned closer to an air-outflow-end side of the slider element compared to a swing fulcrum of the slider element.

2. The magnetic head slider according to claim 1, wherein the recording and/or reproducing magnetic element is disposed at the air-outflow-end side of the slider element.

3. The magnetic head slider according to claim 1, wherein the at least one air-inflow-end-side protrusion surface is disposed at an air-inflow-end side of a surface of the slider element that opposes a magnetic disc, the at least one air-inflow-end-side protrusion surface protrudes towards the magnetic disc.

4. The magnetic head slider according to claim 1, wherein the magnetic element surrounding surface is disposed at the air-outflow-end side of the slider element so as to protrude towards the magnetic disc.

5. The magnetic head slider according to claim 1, wherein the first flow path is disposed between the magnetic element surrounding surface and the at least one air-inflow-end-side protrusion surface and has the form of a groove.

6. The magnetic head slider according to claim 1, wherein the at least one air-inflow-end-side protrusion surface comprises air-inflow-end-side protrusion surfaces that are divided in a widthwise direction that is orthogonal to a lengthwise direction that extends from the air-inflow-end side towards the air-outflow-end side, and wherein the head slider further comprises a second flow path disposed between the air-inflow-end-side protrusion surfaces, the second flow path being connected to the first flow path.

7. The magnetic head slider according to claim 6, wherein a height of a bottom surface defining the first flow path and/or a height of a bottom surface defining the second flow path is greater than a height of a bottom surface defining a groove serving as a negative pressure producing surface and is less than a height of the magnetic element surrounding surface and a height of said at least one air-inflow-end-side protrusion surface.

8. The magnetic head slider according to claim 3, further comprising a plurality of rail surfaces protruding towards the magnetic disc and connecting the magnetic element surrounding surface and said at least one air-inflow-end-side protrusion surface, wherein the first flow path is disposed between the rail surfaces, and a groove that serves as a negative pressure producing surface is disposed at sides of the rail surfaces in the widthwise direction.

9. The magnetic head slider according to claim 1, wherein T1/T2 is in a range of about 0.05 to about 0.5, where T1 denotes a width of the contracted portion and T2 denotes a width of an air-inflow-end-side end of the first flow path.

10. The magnetic head slider according to claim 1, wherein L2/L1 is equal to or greater than about 0.57, where L1 denotes a length of the slider element and L2 denotes a length between the position of the contracted portion and an end surface of the slider element at the air-inflow-end side thereof.

11. A magnetic head slider comprising:
a slider element;
a recording and/or reproducing magnetic element disposed at an end surface of the slider element at an air-outflow-end side thereof;
at least one air-inflow-end-side protrusion surface disposed at an air-inflow-end side of a surface of the slider element opposing a magnetic disc, said at least one air-inflow-end-side protrusion surface protruding towards the magnetic disc;
a magnetic element surrounding surface disposed at the air-outflow-end side of the slider element so as to protrude towards the magnetic disc;
a first flow path disposed between the magnetic element surrounding surface and said at least one air-inflow-end-side protrusion surface and having the form of a groove; and
a contracted portion disposed in the first flow path so as to be positioned closer to the air-outflow-end side of the slider element compared to a swing fulcrum of the slider element.

12. The magnetic head slider according to claim 1, wherein said at least one air-inflow-end-side protrusion surface comprises air-inflow-end-side protrusion surfaces that are divided in a widthwise direction that is orthogonal to a lengthwise direction that extends from the air-inflow-end side towards the air-outflow-end side, and wherein the head slider further comprises a second flow path disposed between the air-inflow-end-side protrusion surfaces, the second flow path being connected to the first flow path.

13. The magnetic head slider according to claim 1, wherein a height of a bottom surface defining the first flow path and/or a height of a bottom surface defining the second flow path is greater than a height of a bottom surface defining a groove serving as a negative pressure producing surface and is less than a height of the magnetic element surrounding surface and a height of said at least one air-inflow-end-side protrusion surface.

14. The magnetic head slider according to claim 1, further comprising a plurality of rail surfaces protruding towards the magnetic disc and connecting the magnetic element surrounding surface and said at least one air-inflow-end-side protrusion surface, wherein the first flow path is disposed between the rail surfaces, and a groove serving as a negative pressure producing surface is disposed at sides of the rail surfaces in the widthwise direction.

15. The magnetic head slider according to claim 1, wherein T1/T2 is in a range of about 0.05 to about 0.5, where T1 denotes a width of the contracted portion and T2 denotes a width of an air-inflow-end-side end of the first flow path.

16. The magnetic head slider according to claim 1, wherein L2/L1 is equal to or greater than about 0.57, where L1 denotes a length of the slider element and L2 denotes a length between the position of the contracted portion and an end surface of the slider element at the air-inflow-end side thereof.
